(19) United States
(12) Patent Application Publication
(10) Pub. No.: US 2009/0092780 A1
(43) Pub. Date: Apr. 9, 2009

(54) Decorative sticker

(75) Inventors: Su-Fen Chen, Tainan Hsien (TW); Yueh-Li Lu, Tainan City (TW)

Correspondence Address: FROMMER LAWRENCE & HAUG, 745 FIFTH AVENUE- 10TH FL., NEW YORK, NY, 10151, US

(73) Assignee: Upikit Stationery Enterprise Co., Ltd.

(21) Appl. No.: 11/973,425

(22) Filed: Oct. 9, 2007

(51) Int. Cl. B32B 33/00

(52) U.S. Cl. 428/41.8

(57) ABSTRACT

A decorative sticker includes: a sheet member having opposite first and second surfaces, the first surface having first and second printed regions; an adhesive layer disposed on the second surface of the sheet member and overlapping the first and second printed regions; a non-sticky coating attached to the adhesive layer and overlapping the second printed region so as to expose a portion of said adhesive layer that corresponds to said first printed region of said sheet member; and a releasable sheet attached to the portion of the adhesive layer and the non-sticky coating.

### BACKGROUND OF THE INVENTION

1. Field of the Invention

This invention relates to a decorative sticker, more particularly to a three-dimensional decorative sticker.

2. Description of the Related Art

FIGS. 1 and 2 show a conventional sticker with a three-dimensional structure, which includes a first adhesive layer 63, a first pattern layer 61 adapted to be adhered to an object 7 through the first adhesive layer 63, a second adhesive layer 64, and a second pattern layer 62 having a first region 621 adhered to the first pattern layer 61 through the second adhesive layer 64, and a second region 622 folded relative to the first region 621. With the first and second pattern layers 61, 62, both of which may have the same pattern, the sticker can be constructed into the three-dimensional structure.

In the method of manufacturing the conventional sticker, an adhesive material used to form the second adhesive layer 64 is applied to the first region 621 of the second pattern layer 62 using a roller. However, since the adhesive material is slightly fluid, it is relatively difficult to control the shape and size of the adhesive material to be applied, which are required to correspond to those of the first region 621 of the second pattern layer 62.

### SUMMARY OF THE INVENTION

Therefore, the object of the present invention is to provide a decorative sticker that can overcome the aforesaid drawback of the prior art.

According to this invention, a decorative sticker includes: a sheet member having opposite first and second surfaces, the first surface having first and second printed regions; an adhesive layer disposed on the second surface of the sheet member and overlapping the first and second printed regions; a non-sticky coating attached to the adhesive layer and overlapping the second printed region so as to expose a portion of the adhesive layer that corresponds to the first printed region of the sheet member; and a releasable sheet attached to the portion of the adhesive layer and the non-sticky coating.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a fragmentary perspective view illustrating a conventional three-dimensional sticker;

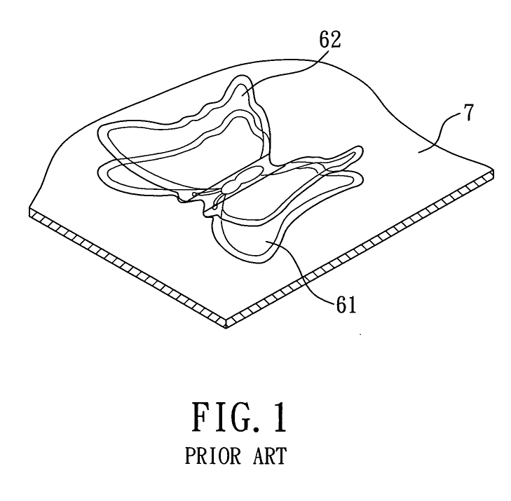

FIG. 2 is a fragmentary cross-sectional view of the conventional three-dimensional sticker shown in FIG. 1;

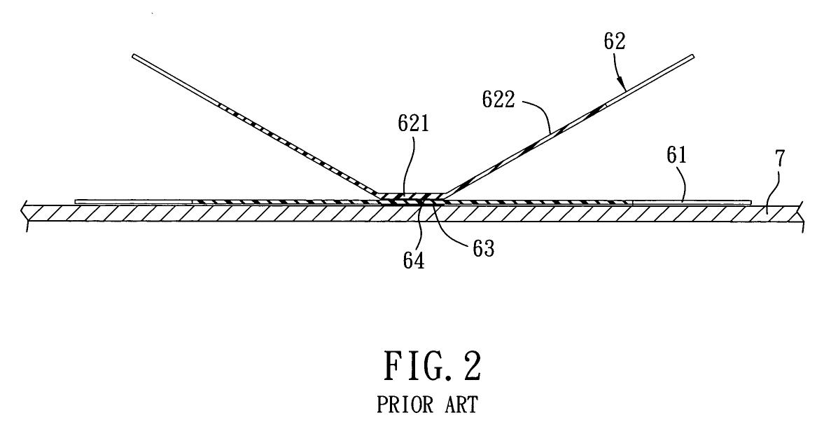

FIG. 3 is a fragmentary perspective view illustrating the preferred embodiment of a decorative sticker according to this invention, which is adhered to an object;

FIG. 4 is a fragmentary cross-sectional view of the preferred embodiment;

FIG. 5 is a fragmentary partly cross-sectional view of the preferred embodiment shown in FIG. 3;

FIG. 6 is a fragmentary exploded perspective view illustrating the preferred embodiment of a decorative article formed of a plurality of decorative stickers according to this invention, which is adhered to an object;

FIG. 7 is a fragmentary assembled perspective view of the decorative article shown in FIG. 6; and

FIG. 8 is a fragmentary partly cross-sectional view of the decorative article shown in FIG. 6.

### DETAILED DESCRIPTION OF THE PREFERRED EMBODIMENTS

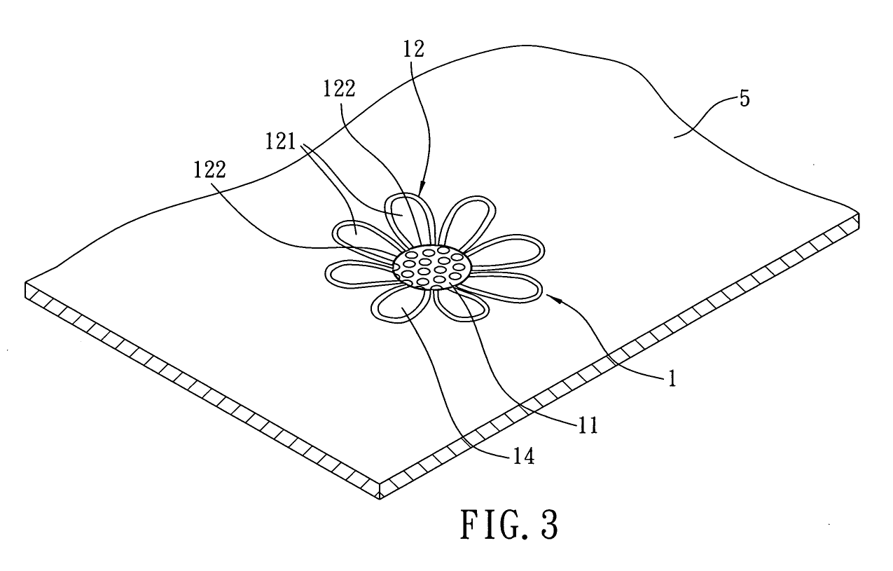

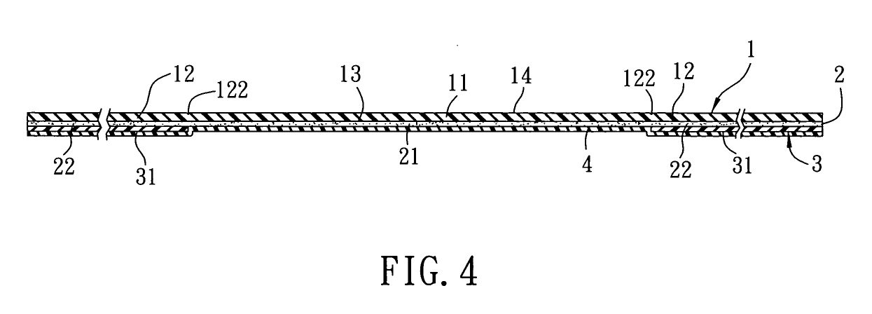

Referring to FIGS. 3 to 5, the first preferred embodiment of a decorative sticker according to the present invention is shown to include a sheet member 1 having opposite first and second surfaces 14, 13, the first surface 14 having first and second printed regions 11, 12; an adhesive layer 2 disposed on the second surface 13 of the sheet member 1 and overlapping the first and second printed regions 11, 12; a non-sticky coating 3 attached to the adhesive layer 2 and overlapping the second printed region 12 so as to expose a portion of the adhesive layer 2 that corresponds to the first printed region 11; and a releasable sheet 4 attached to the portion of the adhesive layer 2 and the non-sticky coating 3.

Preferably, the second printed region 12 has a cutting line 122 formed at a boundary between the first and second printed regions 11, 12.

The sheet member 1 is generally made from a paper material or a plastic material, e.g., PVC, PP, etc. In the preferred embodiment, a plastic material is employed to provide superior structural strength.

Preferably, the non-sticky coating 3 is made from silicon ink. With the non-sticky coating 3, the second printed region 12 is prevented from being adhered to the object 5 and can be folded from the first printed region 11 so as to form a three-dimensional structure.

It should be noted that the structure composed of the first and second printed regions 11, 12, and the color thereof can vary based on actual requirements.

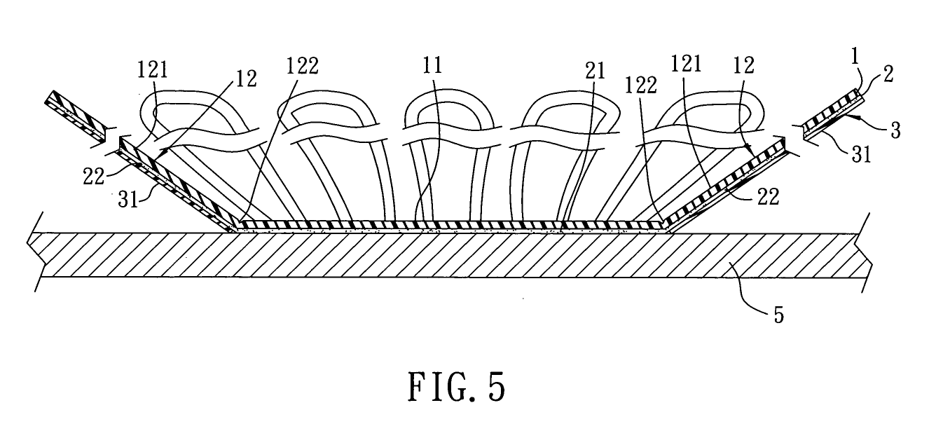

FIGS. 3 and 5 show the decorative sticker attached to an object 5. Note that the releasable paper 4 is removed from the adhesive layer 2 so as to permit construction of the three-dimensional structure.

A method for making the decorative sticker of this invention includes: providing a continuous substrate including a sheet member 1 with an adhesive layer 2 adhered thereon and a releasable paper 4 attached to the adhesive layer 2; removing the releasable paper 4; applying an ink material (e.g., silicon ink) to the adhesive layer 2 at predetermined regions using a roller; curing the ink material using VU light so as to form the non-sticky coating 3; reattaching the releasable paper 4 to the non-sticky coating 3 and a part of the adhesive layer 2 (which is not covered with the non-sticky coating 3); and coloring and cutting the sheet member 1 so as to form a plurality of decorative stickers with the desired pattern. Since the ink material is more viscous than the adhesive material, the shape and size of the ink material applied to the desired regions of the adhesive layer 2 can be better controlled than the adhesive material. Note that the roller employed for application of the ink material is embossed and has a pattern corresponding to that of each region of the adhesive layer 2.

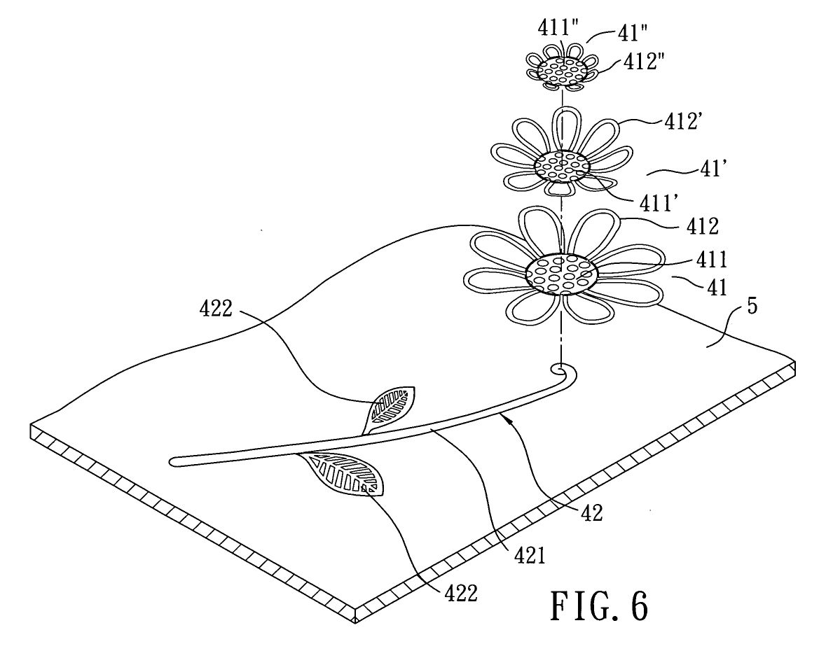

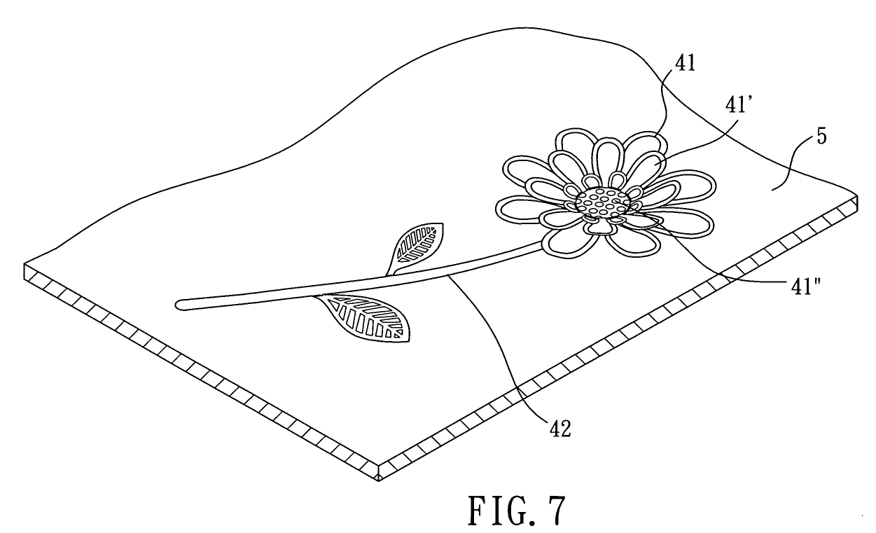

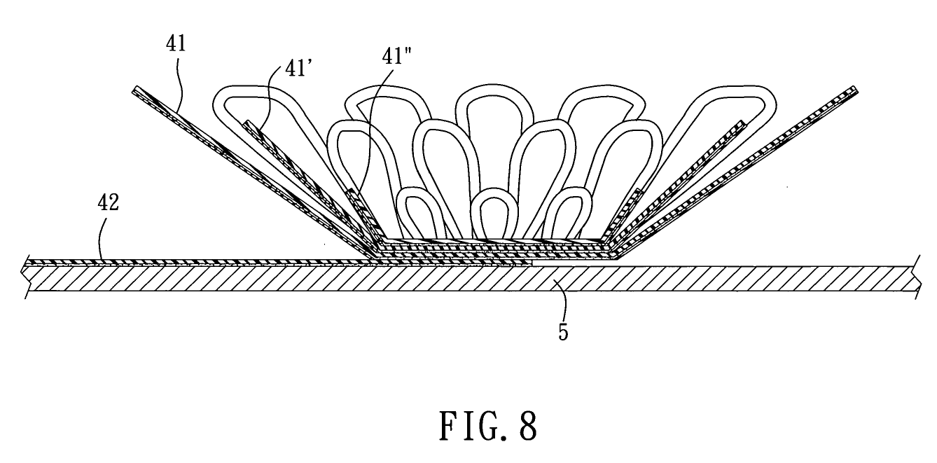

FIGS. 6 to 8 illustrate a decorative article that includes four decorative stickers 42, 41, 41′, 41″, each of which has a similar structure as that of the decorative sticker shown in FIG. 3. To be specific, the first decorative sticker 42 having a stem-and-leaf pattern is firstly adhered to an object 5. The first decorative sticker 42 has a sheet member composed of a first printed region 421 (in the form of a stem and adhered to the object 5 through an adhesive layer (not shown) of the first decorative sticker 42), and a second printed region 422 (in the form of a leaf and folded from the first printed region 421). A second decorative sticker 41 in the form of a flower is then adhered to one end of the first printed region 421 of the first decorative sticker 42 through an adhesive layer (not shown) overlapping a first printed region 411 of a sheet member (not shown) of the second decorative sticker 41. A third decorative sticker 41′, having the same pattern as that of the second decorative sticker 41 but having a smaller size than that of the second decorative sticker 41, is adhered to the second decorative sticker 41 through an adhesive layer (not shown) overlapping a first printed region 411′ of the sheet member (not shown) of the third decorative sticker 41′. Similarly, a fourth decorative sticker 41″, having the same pattern as that of the third decorative sticker 41′ but having a smaller size than that of the third decorative sticker 41′, is adhered to the third decorative sticker 41′ through an adhesive layer (not shown) overlapping a first printed region 411″ of the sheet member (not shown) of the fourth decorative sticker 41″. The decorative article thus formed can enhance the decorative effect and provide a complex configuration.

With the inclusion of the ink material in the decorative sticker of this invention, the aforesaid drawback with respect to the difficulty of controlling the shape and size of the adhesive material to be applied as encountered in the prior art can be eliminated.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A decorative sticker comprising:
a sheet member having opposite first and second surfaces, said first surface having first and second printed regions;
an adhesive layer disposed on said second surface of said sheet member and overlapping said first and second printed regions;
a non-sticky coating attached to said adhesive layer and overlapping said second printed region so as to expose a portion of said adhesive layer that corresponds to said first printed region of said sheet member; and
a releasable sheet attached to said portion of said adhesive layer and said non-sticky coating.

2. The decorative sticker of claim 1, wherein said non-sticky coating is made from an ink material.

3. The decorative sticker of claim 1, wherein said non-sticky coating is made from silicon ink.

4. A three dimensional sticker comprising:
a sheet member having opposite first and second surfaces, said first surface having first and second printed regions, said second printed region being folded from said first printed region;
an adhesive layer disposed on said second surface of said sheet member and overlapping said first and second printed regions; and
a non-sticky coating attached to said adhesive layer and overlapping said second printed region so as to expose a portion of said adhesive layer that corresponds to said first printed region of said sheet member.

5. The three dimensional sticker of claim 4, wherein said non-sticky coating is made from an ink material.

6. The three dimensional sticker of claim 4, wherein said non-sticky coating is made from silicon ink.
